(19) United States
(12) Patent Application Publication
(10) Pub. No.: US 2011/0157638 A1
(43) Pub. Date: Jun. 30, 2011

(54) INFORMATION PROCESSING APPARATUS CAPABLE OF DISPLAYING OPERATION SCREEN PROVIDED BY SERVER, METHOD OF CONTROLLING THE INFORMATION PROCESSING APPARATUS, AND STORAGE MEDIUM

(75) Inventor: Tetsuya YAMADA, Kawasaki-shi (JP)

(73) Assignee: CANON KABUSHIKI KAISHA, Tokyo (JP)

(21) Appl. No.: 12/971,259

(22) Filed: Dec. 17, 2010

(30) Foreign Application Priority Data
Dec. 28, 2009 (JP) 2009-297681

(51) Int. Cl. G06F 3/12

(52) U.S. Cl. 358/1.15

(57) ABSTRACT

An information processing apparatus which makes it possible to display respective pieces of information both on operation screens of an image processing apparatus and the information processing apparatus in a mutually-related manner. A print control apparatus as the information processing apparatus is connected to an MFP via a local network and to a web server via a LAN. The print control apparatus analyzes a first operation screen request from the MFP to thereby determine whether or not it is required to update an operation screen displayed on the print control apparatus. If it is required to update the operation screen, the print control apparatus generates a second operation screen request for requesting an operation screen to be displayed thereon, and transmits the second operation screen request. Further, the print control apparatus transfers the first operation screen request to the web server.

### BACKGROUND OF THE INVENTION

1. Field of the Invention

The present invention relates to an information processing apparatus which is capable of displaying an operation screen provided by a server, a method of controlling the information processing apparatus, and a non-transitory computer-readable storage medium storing a computer-executable program for causing a computer to execute the method.

2. Description of the Related Art

Conventionally, there has been proposed a technique of connecting an information processing apparatus, such as a personal computer, to a web server on a network, and displaying an operation screen provided by the web server on a web browser provided in the information processing apparatus. In this technique, when the web browser of the information processing apparatus requests the web server to provide the operation screen, a web application software program (hereinafter simply referred to as “the web application”) on the web server sends a HTML (HyperText Markup Language) file to the information processing apparatus in response to the request therefrom so as to cause the web browser to display the operation screen. The web browser of the information processing apparatus analyzes the received HTML file and displays the operation screen based on the contents of the HTML file.

Further, when the user inputs an instruction via the operation screen displayed by the web browser of the information processing apparatus, the web browser sends the input instruction to the web server. Upon receipt of the instruction from the web browser, the web application on the web server carries out processing according to the instruction input via the operation screen.

By the way, recently, some of multifunction peripherals (MFPs) having a scanner function and a printer function are equipped with such a web browser as described above. An MFP equipped with the web browser follows the above-described procedure to display an operation screen provided by the web server on the web browser, and receives various user instructions via the operation screen.

Further, in the above-described technical field, there has also been proposed a technique described below (see Japanese Patent Laid-Open Publication No. 2006-129356). According to Japanese Patent Laid-Open Publication No. 2006-129356, a web server provides an operation screen for use in inputting an instruction for using one of the functions (scan, copy, FAX, etc.) of an MFP. More specifically, when a user of the MFP gives an instruction to the MFP via an operation screen displayed by a web browser of the MFP, the web browser of the MFP sends the instruction input via the operation screen to the web server.

Upon receipt of the instruction from the web browser of the MFP, the web server sends to the MFP a request to execute one of various processes according to the instruction input by the user. Upon receipt of the request from the web server, the MFP executes the requested process. This eliminates the need for the MFP to store therein all menu data items for operating the MFP, and makes it possible to easily change menu data on the web server.

On the other hand, there has recently been proposed a system in which an image processing apparatus is separately provided outside an MFP to perform part of the processing conventionally carried out by an MFP. The image processing apparatus is, for example, in the form of a print control apparatus configured to perform high-speed conversion of print data represented in a vector format into bitmap data which can be printed by the MFP and send the resulting bitmap data to the MFP. Some such image processing apparatuses are configured, for example, to include a web server and a web browser, as software, and are each provided with an input unit and an output unit, such as a display device and a keyboard.

In the above-described system comprising the MFP and the information processing apparatus, there are provided two pairs of input and output units (one pair of input and output units for the MFP and the other pair of input and output units for the information processing). Under such conditions, it is demanded that a mutually-related operation is performed between the MFP and the information processing apparatus, for displaying information not only on the display device of the MFP but also on the display device of the information processing apparatus, in accordance with a change in the state of the system caused by an operation performed by the user via the input unit of the MFP. However, conventionally, the MFP and the information processing apparatus each make a query to the web server independently of each other, and this has made it conventionally impossible to meet the above-mentioned demand for the mutually-related operation.

### SUMMARY OF THE INVENTION

The present invention provides an information processing apparatus which makes it possible to display respective pieces of information both on an operation screen of an image processing apparatus and an operation screen of the information processing apparatus in a mutually-related manner, a method of controlling the information processing apparatus, and a non-transitory computer-readable storage medium storing a computer-executable program for causing a computer to execute the method.

In a first aspect of the present invention, there is provided an information processing apparatus that is connected, via a network, to an image processing apparatus capable of displaying an operation screen, and a server having a function of outputting an operation screen in response to a request from an external apparatus, and is capable of displaying an operation screen, comprising an analysis unit configured to perform analysis of a first operation screen request transmitted from the image processing apparatus, a determination unit configured to determine, according to a result of the analysis by the analysis unit, whether or not it is required to update the operation screen displayed on the information processing apparatus, a generation unit configured to be operable when the determination unit determines that it is required to update the operation screen displayed on the information processing apparatus, to generate a second operation screen request for requesting an updated operation screen which is to be displayed on the information processing apparatus, a transmission unit configured to transmit the second operation screen request generated by the generation unit, and a transfer unit configured to transfer the first operation screen request from the image processing apparatus to the server.

In a second aspect of the present invention, there is provided a method of controlling an information processing apparatus that is connected, via a network, to an image processing apparatus capable of displaying an operation screen, and a server having a function of outputting an operation screen in response to a request from an external apparatus, and is capable of displaying an operation screen, comprising performing analysis of a first operation screen request transmitted from the image processing apparatus, determining, according to a result of the analysis, whether or not it is required to update an operation screen displayed on the information processing apparatus, generating, when it is determined that it is required to update the operation screen displayed on the information processing apparatus, a second operation screen request for requesting an updated operation screen which is to be displayed on the information processing apparatus, transmitting the generated second operation screen request, and transferring the first operation screen request from the image processing apparatus to the server.

In a third aspect of the present invention, there is provided a non-transitory computer-readable storage medium storing a computer-executable program for causing a computer to execute a method of controlling an information processing apparatus that is connected, via a network, to an image processing apparatus capable of displaying an operation screen, and a server having a function of outputting an operation screen in response to a request from an external apparatus, and is capable of displaying an operation screen, wherein the method comprises performing analysis of a first operation screen request transmitted from the image processing apparatus, determining, according to a result of the analysis, whether or not it is required to update an operation screen displayed on the information processing apparatus, generating, when it is determined that it is required to update the operation screen displayed on the information processing apparatus, a second operation screen request for requesting an updated operation screen which is to be displayed on the information processing apparatus, transmitting the generated second operation screen request, and transferring the first operation screen request from the image processing apparatus to the server.

According to the present invention, it is determined based on a first operation screen request transmitted from the image processing apparatus, whether or not it is required to update the operation screen displayed on the information processing apparatus, and when it is determined that it is required to update the operation screen, the information processing apparatus generates and transmits a second operation screen request for requesting an updated operation screen which is to be displayed on the information processing apparatus. Further, the information processing apparatus transfers the first operation screen request from the image processing apparatus to the server. This makes it possible to display, respective pieces of information both on an operation screen of the image processing apparatus and an operation screen of the information processing apparatus in a mutually-related manner.

The features and advantages of the invention will become more apparent from the following detailed description taken in conjunction with the accompanying drawings.

### BRIEF DESCRIPTION OF THE DRAWINGS

FIG. 1 is a schematic diagram of an information processing system incorporating a print control apparatus as an information processing apparatus according to an embodiment of the present invention.

FIG. 2 is a block diagram of an MFP in the information processing system.

FIG. 3 is a block diagram of the print control apparatus in the information processing system.

FIG. 4 is a block diagram of a web server in the information processing system.

FIG. 5 is a block diagram showing the software configuration of the entire information processing system.

FIG. 6 is a flowchart of a process executed by a proxy server of the print control apparatus when the print control apparatus receives a request from a web browser of the MFP.

FIG. 7A is a diagram showing an example of a header of a HTTP request issued as an information update request from the MFP to the print control apparatus.

FIG. 7B is a diagram showing an example of a HTML part which is used for displaying a operation screen by the web browser of the MFP.

FIG. 7C is a diagram showing another example of the header of the HTTP request issued as the information update request issued from the MFP to the print control apparatus.

FIG. 8A is a view showing an example of an application menu screen displayed by the web browser of the MFP.

FIG. 8B is a view showing an example of a scan configuration screen displayed by the web browser of the MFP.

FIG. 8C is a view showing an example of a job success screen displayed by the web browser of the MFP.

FIG. 9A is a diagram showing a flow of processing executed from when the MFP issues a screen information request to when a screen obtained thereby is displayed thereon.

FIG. 9B is a diagram showing a flow of processing executed from when the MFP issues a job execution request to when a screen corresponding to a job execution result is displayed thereon.

FIG. 10 is a diagram showing an example of a table for managing pieces of application-specific information.

FIG. 11 is a diagram showing an example of a table that tabulates functions of the MFP available in association with respective operation statuses.

### DETAILED DESCRIPTION OF THE EMBODIMENTS

The present invention will now be described in detail below with reference to the accompanying drawings showing an embodiment thereof. It should be noted that the present invention is not limited to the embodiment described below, and not all combinations of features described in the present embodiment are essential to solution means of the present invention.

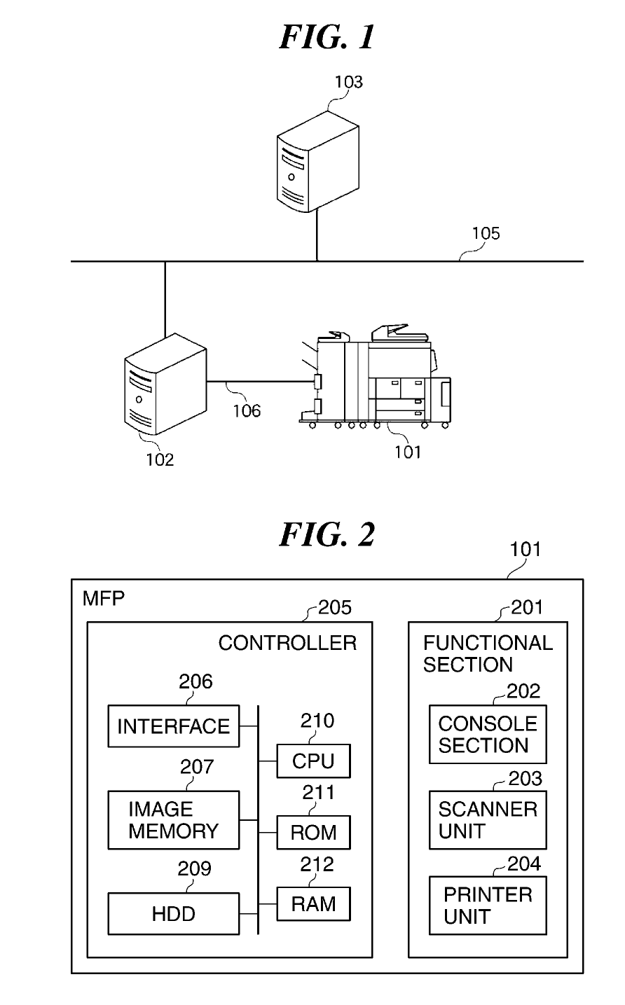

FIG. 1 is a schematic diagram of an information processing system incorporating a print control apparatus 102 as an information processing apparatus according to the embodiment of the present invention.

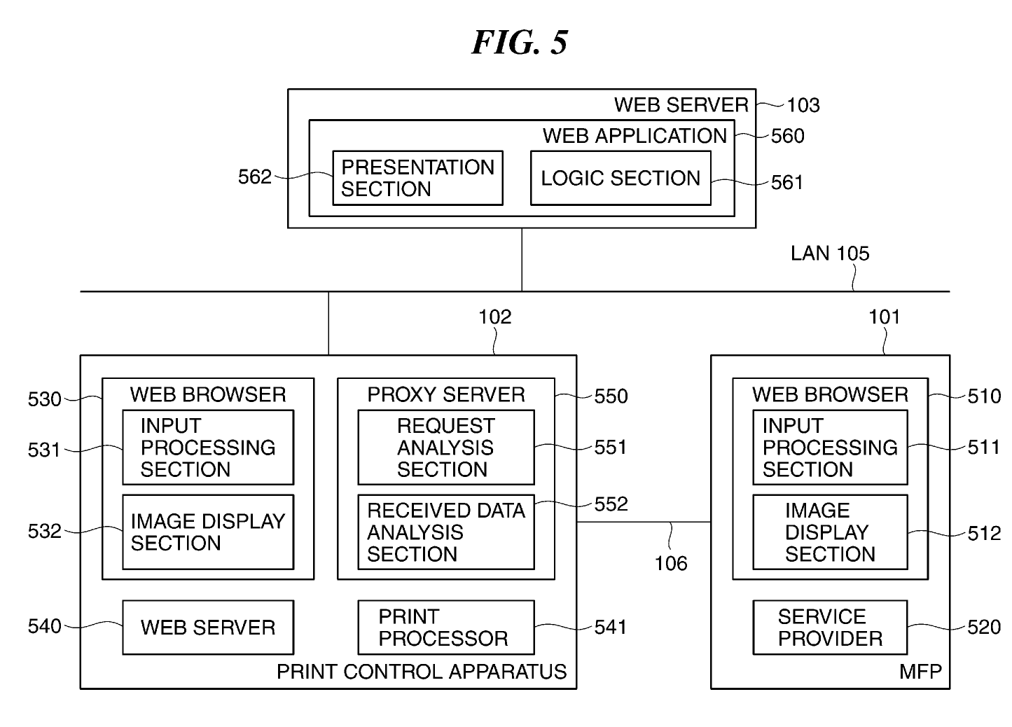

As shown in FIG. 1, the information processing system comprises an MFP 101 (image processing apparatus), the print control apparatus 102 (information processing apparatus), and a web server 103 (server). The print control apparatus 102 and the web server 103 are communicably connected to each other via a LAN (Local Area Network) 105. Further, the MFP 101 and the print control apparatus 102 are communicably connected to each other via a local network 106. The MFP 101 is capable of displaying an operation screen. The print control apparatus 102 is also capable of displaying an operation screen, and is provided with a web server. The web server 103 has the function of generating an operation screen in response to a request from an external apparatus. Details of the information processing system will be described hereafter with reference to FIG. 5 and other figures.

FIG. 2 is a block diagram of the MFP 101 in the information processing system in FIG. 1.

As shown in FIG. 2, the MFP 101 comprises a functional section 201 and a controller 205. The functional section 201 is connected to the controller 205. The functional section 201 comprises an console section 202, a scanner unit 203, and a printer unit 204. The controller 205 comprises an interface 206, an image memory 207, an HDD (hard disk drive) 209, a CPU 210, a ROM 211, and a RAM 212.

The controller 205 controls the overall operation of the MFP 101. The CPU 210 reads out a control program stored in the ROM 211 and executes an associated one of various control processes, such as a read control process and a transmission control process. The RAM 212 is a main memory of the CPU 210, and is used as a temporary storage area, such as a work area. The HDD 209 stores image data and various programs. The console section 202 includes a liquid crystal display, not shown, equipped with a touch panel function, and a keyboard, not shown. Further, the console section 202 is provided with a web browser function, described hereinafter. The MFP 101 uses the web browser function to analyze a HTML file received from the print control apparatus 102 and display an operation screen on the liquid crystal display of the console section 202, based on a description in the received HTML file.

The scanner unit 203 reads an image from an original set in the MFP 101 to generate image data, and inputs the generated image data to the controller 205. The printer unit 204 prints an image on a sheet based on print image data (print data) received from the controller 205. The interface 206 connects the controller 205 to the local network 106 to receive various kinds of information including print data from the print control apparatus 102, and screen data to be displayed on the console section 202. It should be noted that print data received by the MFP 101 from the print control apparatus 102 is temporarily stored in the image memory 207 of the controller 205, and is printed by the printer unit 204 under the control of the controller 205.

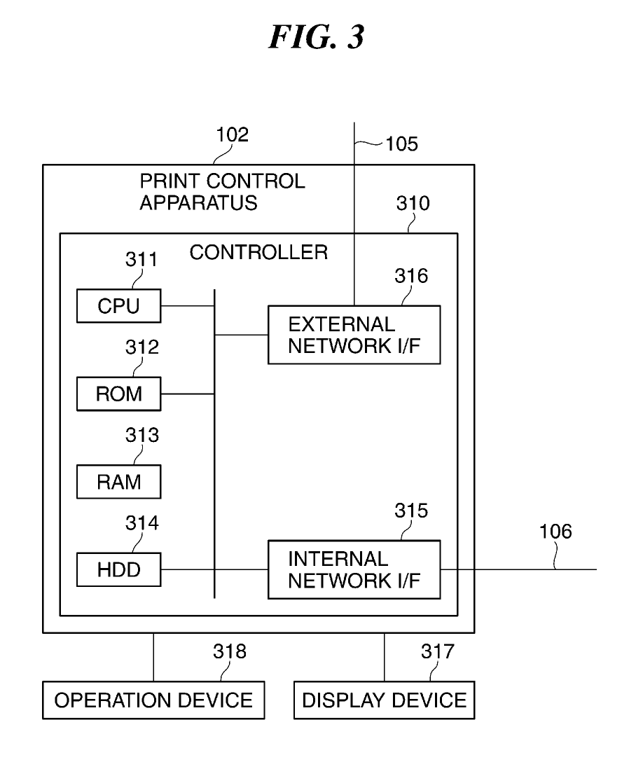

FIG. 3 is a block diagram of the print control apparatus 102 in the information processing system.

As shown in FIG. 3, the print control apparatus 102 comprises a controller 310 comprising a CPU 311, a ROM 312, a RAM 313, a HDD 314, an internal network interface 315, and an external network interface 316. The controller 310 controls the overall operation of the print control apparatus 102. The CPU 311 reads out a control program stored in the ROM 312 and executes an associated one of various control processes. The RAM 313 is a main memory of the CPU 311, and is used as a temporary storage area, such as a work area. The HDD 314 stores image data and various programs.

The internal network interface 315 connects the controller 310 to the local network 106. The external network interface 316 connects the controller 310 to another information processing apparatus (the web server 103 in the present embodiment) on the LAN 105. A display device 317 is implemented e.g. by a liquid crystal display. An operation device 318 comprises a keyboard, not shown, and a mouse, not shown. The display device 317 and the operation device 318 provide user interface for operating the print control apparatus 102.

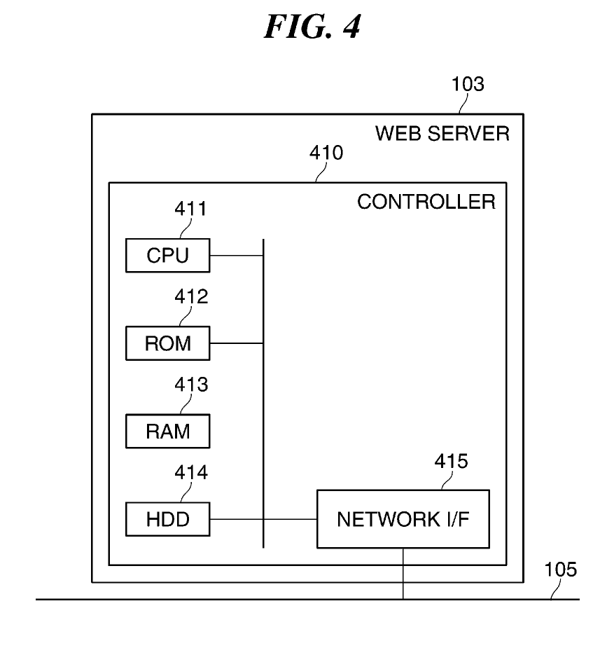

FIG. 4 is a block diagram of the web server 103 in the information processing system.

As shown in FIG. 4, the web server 103 includes a controller 410 comprising a CPU 411, a ROM 412, a RAM 413, a HDD 414, and a network interface 415. The controller 410 controls the overall operation of the web server 103. The CPU 411 reads out a control program stored in the ROM 412 and executes an associated one of various control processes. The RAM 413 is a main memory of the CPU 411, and is used as a temporary storage area, such as a work area. The HDD 414 stores image data and various programs. The network interface 415 connects the controller 410 to the LAN 105.

FIG. 5 is a block diagram showing the software configuration of the entire information processing system.

In FIG. 5, functional blocks appearing in FIG. 5 are realized by execution of control programs by the CPUs provided, respectively, in the MFP 101, the print control apparatus 102, and the web server 103. The MFP 101 has a web browser 510 comprising an input processing section 511 and an image display section 512, and a service provider 520. The print control apparatus 102 has a web browser 530 comprising an input processing section 531 and an image display section 532, a web server 540, a print processor 541, and a proxy server 550 comprising a request analysis section 551 and a received data analysis section 552. The web server 103 has a web application 560 comprising a logic section 561 and a presentation section 562.

In the MFP 101, the input processing section 511 of the web browser 510 analyzes an operation performed by the user via the console section 202 and then transmits a screen update request via the interface 206 according to the HTTP (HyperText Transfer Protocol). The image display section 512 analyzes a HTML file received from the print control apparatus 102 and displays an operation screen on the console section 202. The operation screen thus displayed will be hereinafter referred to as “the web browser screen”. The service provider 520 receives a processing request from the logic section 561 within the web application 560 of the web server 103 via the interface 206 and generates and executes a job for executing an associated process.

The web browser 530 of the print control apparatus 102 has the same functions as those of the web browser 510 of the MFP 101. The web server 540 (server functional section) receives a request from the web browser 510 of the MFP 101 or the web browser 530 of the print control apparatus 102 via the proxy server 550, and generates a screen according to the request to output the screen as a reply. The print processor 541 receives PDL (Printer Description Language) data as print data from a print application (not shown) on the network. Further, the print processor 541 converts the print data into image data printable by the MFP 101 and sends the resulting image data to the MFP 101, thereby causing the MFP 101 to control the printer unit 204 to print the image data on a sheet.

The proxy server 550 controls information flowing between the LAN 105 and the local network 106. The proxy server 550 receives a request from the web browser 510 of the print control apparatus 102 or the web browser 530 of the MFP 101 and transfers the request to an appropriate one of the web server 540 in the print control apparatus 102 and the web server 103 on the LAN 105. The request analysis section 551 analyzes the contents of the request so as to select between the web server 540 and the web server 103 for the transfer. Further, the request analysis section 551 receives a HTML file from one of the web servers and transfers the same to a web browser on a requesting side. The received data analysis section 552 analyzes the contents of the HTML file for the data transfer.

In the web server 103, the presentation section 562 of the web application 560 generates an operation screen to be displayed on the web browser of an external apparatus, in response to a request from the external apparatus, and outputs the screen as a reply. When the web server 103 receives a request for processing by the MFP 101 from the external apparatus, the web application 560 executes various processes according to the contents of the request, and then requests the MFP 101 to execute the requested processing. Examples of the requested processing include a print process by the printer unit 204, a original reading process by the scanner unit 203, and a transmission process performed via the interface 206.

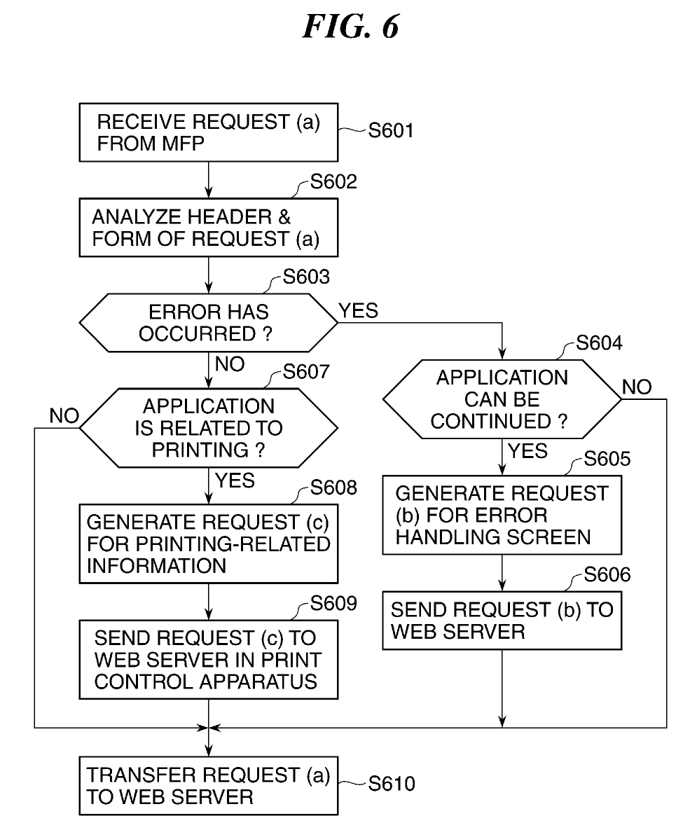

Next, with reference to FIGS. 6 to 11, a description will be given of the operation of the information processing system, configured as described above, which includes the print control apparatus 102 as the information processing apparatus according to the present embodiment.

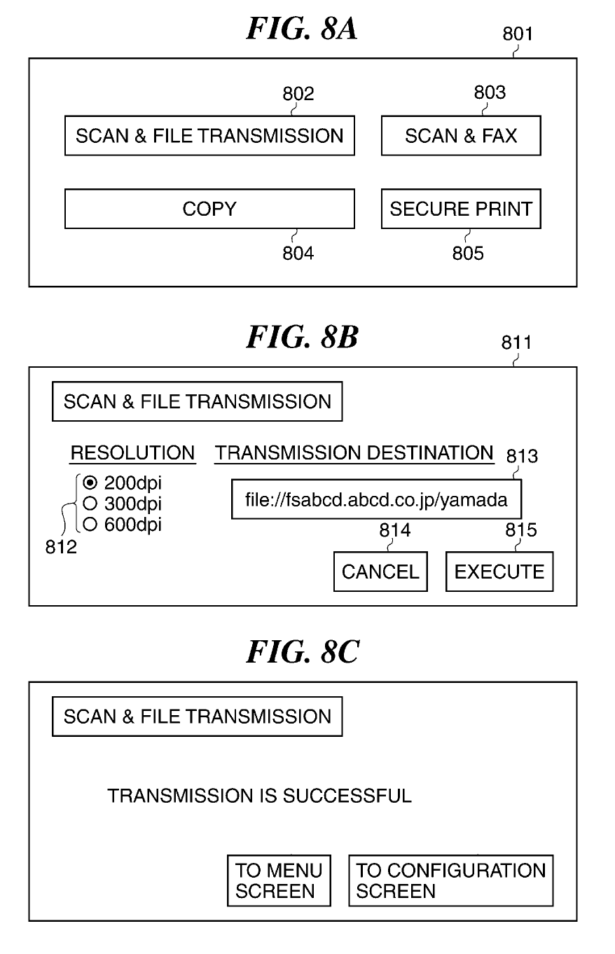

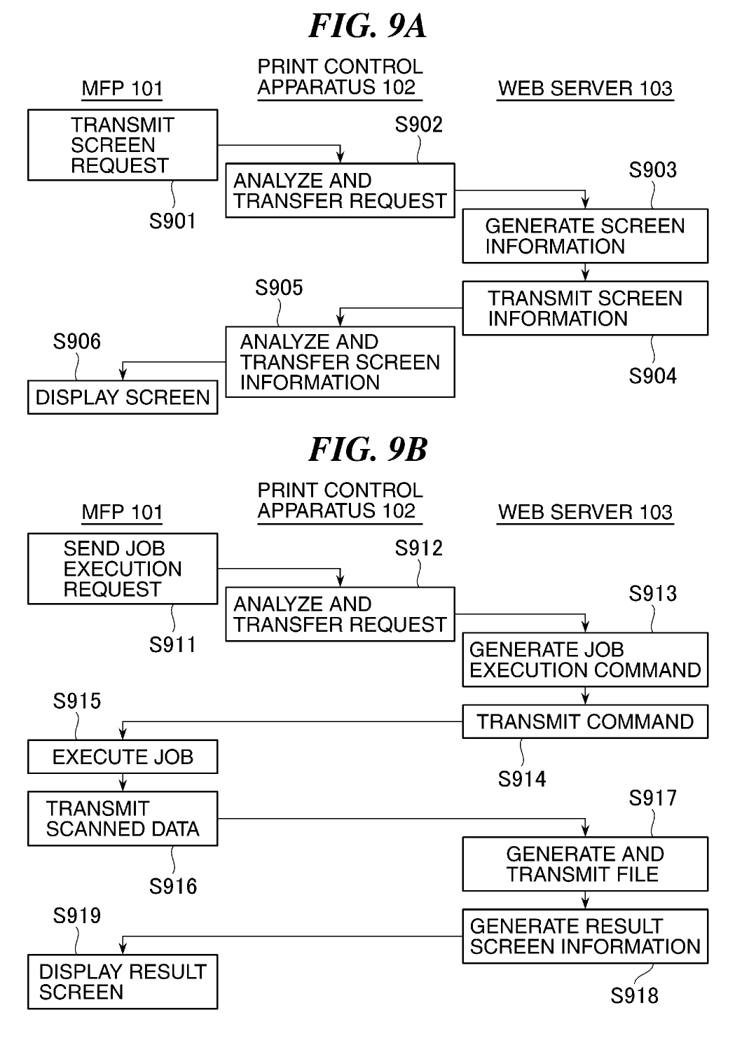

The flow of execution of an application by the information processing system will be described briefly, by referring to examples of screens displayed by the web browser 510 of the MFP 101, which are illustrated in FIGS. 8A to 8C, and examples of processes carried out when the application functions, which are illustrated in FIGS. 9A and 9B.

FIG. 8A is a view showing an example of an application menu screen displayed by the web browser 510 of the MFP 101. FIG. 8B is a view showing an example of a scan configuration screen. FIG. 8C is a view showing an example of a job success screen.

The application menu screen 801 in FIG. 8A is an initial screen on which button controls 802 to 805 are displayed. More specifically, a “scan & file transmission” button 802, a “scan & FAX” button 803, a “copy” button 804, and a “secure print” button 805 are displayed on the application menu screen 801. When the user presses one of these buttons 802 to 805 on the initial screen, the screen is switched to a configuration screen associated with an application assigned to the pressed button.

The scan configuration screen 811 in FIG. 8B is a screen switchingly displayed when the “scan & file transmission” button 802 is pressed on the application menu screen 801. The scan configuration screen 811 is a screen for an application that causes the scanner unit 203 to scan an original and transfers image data read from the original as a file to a designated folder. On the scan configuration screen 811, it is possible to set a resolution using a radio button control 812 and set a transfer destination folder using a textbox control 813. When a “cancel” button 814 is pressed, the screen is witched to the application menu screen 801.

In displaying a screen, such as the application menu screen 801 or the scan configuration screen 811, provided by the web server 103 on the MFP 101, a process shown in FIG. 9A is carried out.

FIG. 9A is a diagram showing a flow of processing executed from when the MFP 101 issues a screen information request to when a screen obtained thereby is displayed on the MFP 101.

As shown in FIG. 9A, first, the MFP 101 sends a request (HTTP request) for screen information to be displayed by the web browser 510 of its own to the print control apparatus 102 (step S901). The proxy server 550 of the print control apparatus 102 analyzes the screen information request sent from the MFP 101 and then transfers the analyzed screen information request to the web server 103 (step S902).

Upon receipt of the screen information request from the print control apparatus 102, the web server 103 generates screen information (HTML) (step S903) and sends a HTTP response containing the screen information as to the print control apparatus 102 (step S904). The proxy server 550 of the print control apparatus 102 analyzes the HTTP response sent from the web server 103 to determine a transfer destination of the HTTP response, and then transfers the HTTP response to the MFP 101 (step S905). The MFP 101 causes the web browser 510 of its own to display the scan configuration screen 811 (step S906).

When the user presses an “execute” button 815 on the scan configuration screen 811 displayed by the web browser 510 of the MFP 101, a process shown in FIG. 9B is carried out.

FIG. 9B is a diagram showing a flow of processing executed from when the MFP 101 issues a job execution request to when a screen corresponding to a job execution result is displayed thereon.

As shown in FIG. 9B, the MFP 101 generates a job execution request in response to depression of the “execute” button 815 on the scan configuration screen 811 and sends the job execution request to the print control apparatus 102 (step S911). The proxy server 550 of the print control apparatus 102 analyzes the job execution request sent from the MFP 101 and then transfers the analyzed job execution request to the web server 103 (step S912).

Upon receipt of the job execution request from the print control apparatus 102, the web server 103 generates a command for job execution (step S913) and sends the command to the MFP 101 (step S914). In doing this, a Web service protocol is used as a transmission protocol.

In the MFP 101, the service provider 520 performs transmission, reception, and processing of a command by the Web service protocol. Upon receipt of the above command sent from the web server 103, the MFP 101 executes a scan job for reading an image from an original according to the set conditions (step S915) and sends image data (scanned data) read from the original to the web server 103 (step S916). If the scan is unsuccessful, the MFP 101 sends information indicating the fact to the web server 103.

Upon receipt of the scanned data from the MFP 101, the web server 103 generates a file and sends the generated file to a designated folder (transfer destination folder designated using the textbox control 813 in FIG. 8B) (step S917). Then, the web server 103 generates a screen corresponding to a job execution result and sends job result screen information to the MFP 101 (step S918). Upon receipt of the job result screen information from the web server 103, the MFP 101 displays the screen corresponding to the job execution result (step S919). The job success screen in FIG. 8C is an example of the screen corresponding to the job execution result.

Next, processing executed by the print control apparatus 102 will be described with reference to FIGS. 6 to 11.

FIG. 6 is a flowchart of a process executed by the proxy server 550 of the print control apparatus 102 when the print control apparatus 102 receives a request from the web browser 550 of the MFP 101.

In FIG. 6, the proxy server 550 of the print control apparatus 102 receives an information update request (first operation screen request) from the MFP 101 (hereinafter referred to as “the request (a)”) (step S601), and analyzes the request (a) (step S602). In the present embodiment, the proxy server 550 analyzes the HTTP request header of the request (a) and FORM data included in the request (a), the FORM data having been extracted by the MFP 101 from HTML data received from the web server 103 for displaying an operation screen on the MFP 101.

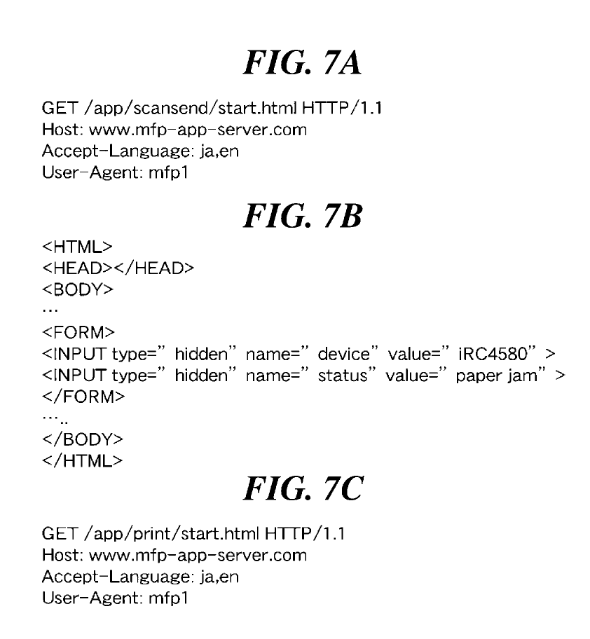

In the analysis of the HTTP request header, the proxy server 550 determines an application which the user has requested to use, based on a URL (Uniform Resource Locator) described in the HTTP request header. FIG. 7A shows an example of the request transmitted in the step S901 in FIG. 9A when the “scan & file transmission” button 802 is pressed on the application menu screen 801 of the MFP 101. In the URL, the application is indicated at a position where a character string of which the illustrated example is “/scansend/” appears, and in the present case, it is determined by the character string that the “scan & file transmission” application is requested to be used.

In the analysis of the FORM data, in the present embodiment, from the FORM data included in the HTTP request, the proxy server 550 acquires the model and operation status of the MFP 101. That is, the proxy server 550 acquires the information of “device” and “status”, respectively, as model information and operation status information. The illustrated example in FIG. 7B shows that the value of “device” is equal to “iRC4580” and the value of “status” is equal to “paper jam”, from which it is known that the model of the MFP 101 is “iRC4580” and a paper jam has occurred in the MFP 101.

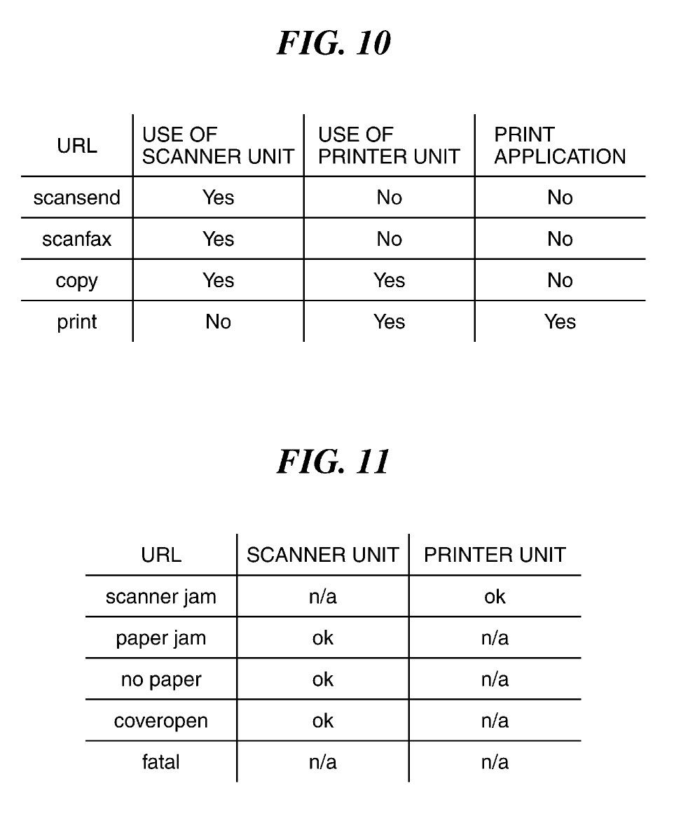

Then, the proxy server 550 determines whether or not an error has occurred (step S603). If the proxy server 550 determines an occurrence of an error as the operation status of the MFP 101, the proxy server 550 determines whether or not execution of the application can be continued in the MFP 101 (step S604). For example, when a paper jam has occurred in the MFP 101, it is determined that an application involving an operation for forming an image on a sheet cannot be executed in the MFP 101, but an application which does not involve the image forming operation can be continued. Tables shown in FIGS. 10 and 11 are referred to for this determination. These tables are prepared and stored in advance in the HDD 314 of the print control apparatus 101, and the CPU 311 reads out into the RAM 313 when executing the present process.

FIG. 10 is a diagram showing an example of a table for managing pieces of application-specific information. The column of “URL” column shows applications each represented by a character string described in a URL in the header of a HTTP request. In the column of “URL”, the character string “scansend” represents the “scan & file transmission” application, a character string “scanfax” represents a “scan & FAX” application, and a character string “copy” represents a “copy” application. Further, a character string “print” represents a “print” application. In the column of “use of scanner unit” and the column of “use of printer unit”, there are indicated whether each application in the “URL” column uses the function of the scanner unit 203 of the MFP 101 and whether the application uses the function of the printer unit 204 of the MFP 101 in respective boxes associated with the application. In the column of “print application”, there are indicated whether each application is related to printing. This column is used to determine whether or not the print control apparatus 102 is to be used.

FIG. 11 is a diagram showing an example of a table that tabulates functions of the MFP available in association with respective operation statuses. In the column of “URL”, a character string “scanner jam” represents “occurrence of an original jam in the scanner unit”, a character string “paper jam” represents “occurrence of a paper jam in the printer unit”, and a character string “no paper” represents “running out of sheets”. Further, a character string “coveropen” represents “state of the maintenance cover of the MFP being open”, and a character string “fatal” represents “occurrence of a fatal failure”. In the column of “scanner unit” column and the column of “printer unit”, there are indicated whether each of the scanner unit 203 and the printer unit 204 is available (ok) or unavailable (n/a) in respective boxes associated with each of the operation statuses.

In a case where the request based on the example shown in FIGS. 7A and 7B is issued, the associated application is represented by “scansend”, and hence the printer unit 204 (printer engine) is not used. In this case, even when the operation status is determined as “paper jam” as shown in FIG. 7B, the scanner unit 203 is available. Therefore, it is determined that execution of the application can be continued in the MFP 101. When the execution of the application can be continued in the MFP 101, the scan configuration screen 811 is caused to be displayed on the console section 202 of the MFP 101 so as to enable the user to operate the application (“scan & file transmission”). At the same time, a screen for error handling is caused to be displayed on the display device 317 of the print control apparatus 102 so as to have the user recover the error.

For the above-mentioned purposes, the proxy server 550 generates a request for an error handling screen (hereinafter referred to as the request (b)) (second operation screen request) (step S605). In the present embodiment, the error handling screen is provided by the web server 103, and therefore the proxy server 550 sends the request (b) to the web server 103 (step S606).

On the other hand, if it is determined in the step S603 that no error has occurred in the MFP 101, the proxy server 550 determines, using the table in FIG. 10, whether or not the application to be executed by the MFP 101 is related to printing (step S607). If the application is related to printing, as indicated by the header of a HTTP request illustrated in FIG. 7C, the proxy server 550 generates a request (request (c)) (second operation screen request) for displaying information concerning print settings and status, which is managed by the print control apparatus 102, on the display device 317 of the print control apparatus 102 (step S608). Then, the proxy server 550 sends the request (c) to the web server 540 within the print control apparatus 102 (step S609).

On the other hand, if it is determined in the step S604 that the execution of the application cannot be continued or if it is determined in the step S607 that the application is not related to printing, the proxy server 550 sends (transfers) the request (a) from the MFP 101 (first operation screen request) to the web server 103 (step S601). After execution of the step S606 or 5609 as well, the proxy server 550 sends (transfers) the request (a) to the web server 103 (step S610).

As described above, when no error has occurred in the MFP 101 and when an application is related to printing, a request (second operation screen request) for displaying information concerning print settings and status on the print control apparatus 102 is sent to the web server 540 within the print control apparatus 102. On the other hand, when the application is not related to printing, the operation screen request from the MFP 101 (first operation screen request) is transferred to the web server 103. Further, when an error has occurred in the MFP 101 but when an application can be continued in the MFP 101, a request for an error handling screen (second operation screen request) is sent to the web server 103. On the other hand, when the application cannot be continued, the operation screen request from the MFP 101 is transferred to the web server 103. This makes it possible to display respective pieces of information on both the MFP and the print control apparatus in a mutually-related manner.

As described in detail heretofore, according to the present embodiment, the print control apparatus 102 analyzes an operation screen request sent from the MFP 101 and determines whether or not it is required to display information on an operation screen of the print control apparatus 102. Then, if it is required to display the information, the print control apparatus 102 generates an operation screen request for displaying information on the operation screen and sends the operation screen request to the web server 103 or the web server 540 in the print control apparatus 102. Further, the print control apparatus transfers the operation screen request sent from the MFP 101 to the web server 103. This makes it possible to display respective pieces of information on both the console section 202 (operation screen) of the MFP 101 and the display device 317 (operation screen) of the print control apparatus 102 in a mutually-related manner.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all modifications, equivalent structures and functions.

This application claims priority from Japanese Patent Application No. 2009-297681 filed Dec. 28, 2009, which is hereby incorporated by reference herein in its entirety.

What is claimed is:

1. An information processing apparatus that is connected, via a network, to an image processing apparatus capable of displaying an operation screen, and a server having a function of outputting an operation screen in response to a request from an external apparatus, and is capable of displaying an operation screen, comprising:
an analysis unit configured to perform analysis of a first operation screen request transmitted from the image processing apparatus;
a determination unit configured to determine, according to a result of the analysis by said analysis unit, whether or not it is required to update an operation screen displayed on the information processing apparatus;
a generation unit configured to be operable when said determination unit determines that it is required to update the operation screen displayed on the information processing apparatus, to generate a second operation screen request for requesting an updated operation screen which is to be displayed on the information processing apparatus;
a transmission unit configured to transmit the second operation screen request generated by said generation unit; and
a transfer unit configured to transfer the first operation screen request from the image processing apparatus to the server.

2. The information processing apparatus according to claim 1, wherein the server is configured as a web server, and
wherein said analysis unit analyzes a header of a HTTP request received from the image processing apparatus as the first operation screen request, and determines an application software program use of which is requested by a user.

3. The information processing apparatus according to claim 1, wherein said analysis unit analyzes FORM data of a HTTP request received from the image processing apparatus as the first operation screen request, to thereby acquire information on a model and an operation status of the image processing apparatus.

4. The information processing apparatus according to claim 1, wherein said transmission unit sends the second operation screen request to the server.

5. The information processing apparatus according to claim 1, wherein said transmission unit sends the second operation screen request to a server functional section provided in the information processing apparatus.

6. A method of controlling an information processing apparatus that is connected, via a network, to an image processing apparatus capable of displaying an operation screen, and a server having a function of outputting an operation screen in response to a request from an external apparatus, and is capable of displaying an operation screen, comprising:
performing analysis of a first operation screen request transmitted from the image processing apparatus;
determining, according to a result of the analysis, whether or not it is required to update an operation screen displayed on the information processing apparatus;
generating, when it is determined that it is required to update the operation screen displayed on the information processing apparatus, a second operation screen request for requesting an updated operation screen which is to be displayed on the information processing apparatus;
transmitting the generated second operation screen request; and
transferring the first operation screen request from the image processing apparatus to the server.

7. A non-transitory computer-readable storage medium storing a computer-executable program for causing a computer to execute a method of controlling an information processing apparatus that is connected, via a network, to an image processing apparatus capable of displaying an operation screen, and a server having a function of outputting an operation screen in response to a request from an external apparatus, and is capable of displaying an operation screen,
wherein the method comprises:
performing analysis of a first operation screen request transmitted from the image processing apparatus;
determining, according to a result of the analysis, whether or not it is required to update an operation screen displayed on the information processing apparatus;
generating, when it is determined that it is required to update the operation screen displayed on the information processing apparatus, a second operation screen request for requesting an updated operation screen which is to be displayed on the information processing apparatus;
transmitting the generated second operation screen request; and
transferring the first operation screen request from the image processing apparatus to the server.
